(19) United States
(12) Patent Application Publication
(10) Pub. No.: US 2015/0367295 A1
(43) Pub. Date: Dec. 24, 2015

(54) HANDY PUMP

(71) Applicant: DENSO CORPORATION, Kariya-city (JP)

(72) Inventors: Hiroyuki OKUMURA, Tokai-city (JP); Minoru HATANO, Hoi-gun (JP)

(21) Appl. No.: 14/741,516

(22) Filed: Jun. 17, 2015

(30) Foreign Application Priority Data
Jun. 18, 2014 (JP) 2014-125354

(51) Int. Cl. B01F 3/04; F04B 45/047; F04B 35/04; F04B 37/00; F04C 18/344; F04C 29/00

(52) U.S. Cl. CPC B01F 3/04099; F04C 18/344; F04C 29/0085; F04B 35/04; F04B 37/00; F04B 45/047; B01F 2215/007

(57) ABSTRACT

A handy pump has a head and a body. A display window is disposed on an outer circumference of the head to surround the head. A light-guide plate is disposed to guide light from a light source to the display window. The light source is controlled to display operating states of the handy pump. A clearance and a clearance for ventilation are defined within a guide cap when the guide cap is placed to cover a plug and a container. The handy pump discharges air downwardly from inside of the guide cap along the outside of the plug and the container.

### CROSS REFERENCE TO RELATED APPLICATION

This application is based on Japanese Patent Application No. 2014-125354 filed on Jun. 18, 2014, the disclosure of which is incorporated herein by reference.

### TECHNICAL FIELD

The present disclosure relates to a handy pump.

### BACKGROUND

Patent Literatures 1-4 disclose home use pumps. The pump pressurizes or decompresses an inside of a container which accommodated objects, such as a drink. The pump is used to reduce deterioration of a housed object.

### PATENT LITERATURES

Patent Literature 1: JP2003-175960A

Patent Literature 2: JP2014-15225A

Patent Literature 3: Design Patent JP1468510

Patent Literature 4: U.S. Pat. No. 7,198,074

### SUMMARY

Since the pumps disclosed in Patent Literatures 1-4 are held by a user's hand, there may be some concerns. The one is caused by covering the surface of the pump by a user's hand. One example is produced when a user's hand plugs up a vent hole for pressurization or decompression. In this case, the pump may be unable to perform sufficient function. In the above viewpoint, or in the other viewpoint not mentioned above, further improvement of a handy pump is still demanded.

One of objects of invention is to provide a handy pump which can function even if a part of the handy pump is covered by a user's hand.

One of objects of invention is to provide a handy pump which has a passage that is hard to be plugged.

One of objects of invention is to provide a handy pump which can reduce air flow speed at a communicating portion to the air.

One of objects of invention is to provide a handy pump which makes air flow hard to be felt by a user.

The present disclosure employs the following technical means, in order to attain the above-mentioned object.

The present disclosure provides a handy pump. The handy pump comprises an electric pump device which sucks or discharges air through a nozzle, and a handy case which accommodates the electric pump device. The case has a clearance for ventilation which is arranged on a radial outside of the nozzle to surround the nozzle and communicates the electric pump device and the air.

The clearance communicating the electric pump device and the air, i.e., an outward clearance, is arranged on the radial outside of the nozzle and to surround the nozzle. Since air flow passing through the clearance flows to surround the nozzle at the radial outside of the nozzle, the air flow will be distributed over a wide range. According to this structure, it is possible to reduce possibilities that a user's hand covers up all the clearances.

The present disclosure provides a handy pump. The handy pump comprised an electric pump device which sucks or discharges air through a nozzle, and a handy case which accommodates the electric pump device. The case includes a guide cap which is disposed to surround the nozzle at the radial outside of the nozzle, and extends higher than the nozzle. The case includes a clearance for ventilation which is arranged on a radial outside of the nozzle and arranged on a radial inside of the guide cap, and communicates the electric pump device and the air.

The clearance communicating the electric pump device and the air, i.e., an outward clearance, is arranged on the radial outside of the nozzle and on the radial inside of the guide cap. Air flow passing through the clearance flows at the radial outside of the nozzle. In addition, the air flow passes through the radial inside of the guide cap. According to this structure, it is possible to reduce possibilities that a user's hand covers up all the clearances.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a perspective view of a handy pump according to a first embodiment;

FIG. 2 is a cross-sectional view of the handy pump according to the first embodiment;

FIG. 3 is a perspective view of a plug according to the first embodiment;

FIG. 4 is a perspective view of a component according to the first embodiment;

FIG. 5 is a cross-sectional view of a component according to the first embodiment;

FIG. 6 is an enlarged cross-sectional view of a component according to the first embodiment;

FIG. 7 is an exploded perspective view of the handy pump according to the first embodiment;

FIG. 8 is a bottom view of the handy pump according to the first embodiment;

FIG. 9 is a perspective view showing a use of the handy pump according to the first embodiment;

FIG. 10 is a perspective view of a handy pump according to a second embodiment;

FIG. 11 is a perspective view of a handy pump according to a third embodiment;

FIG. 12 is a perspective view of a handy pump according to a fourth embodiment; and

FIG. 13 is a perspective view of a handy pump according to a fifth embodiment.

### DETAILED DESCRIPTION

Referring to drawings, embodiments of the present disclosure will be described hereinafter. In the embodiments, the same parts and components as those in each embodiment are indicated with the same reference numbers and the same descriptions will not be reiterated. In a consecutive embodiment, a correspondence is shown by using a similar reference symbol in which only hundred and more digits differ to indicate a part corresponding to a matter described in the previous embodiment, and the same description may not be repeated. In a case that only a part of component or part is described, other descriptions for the other embodiment may be referenced or incorporated as descriptions for the remaining part of component or part.

### First Embodiment

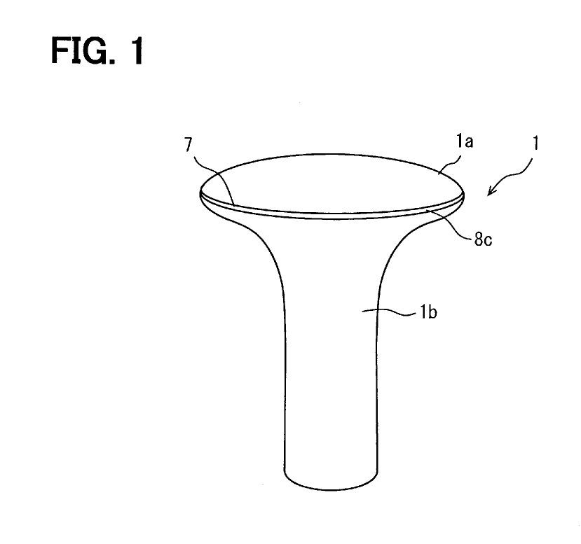

Referring to FIG. 1, a handy pump 1 has size and weight to be held by a user's hand. The handy pump 1 is generally formed in a T shape. The handy pump 1 has a head 1a and a body 1b. The head 1a and the body 1b have a thickness which a user can grasp by hand. The handy pump 1 has a surface formed of a smooth curved surface. A shape of the heat 1a in a horizontal cross section is an ellipse form. The head 1a is formed to become thin, as it goes to both lateral ends. The body 1b extends from the head 1a. A shape of the body 1b in a horizontal cross section gradually changes, from the head 1a to the bottom end, from an ellipse to a circle. The head 1a and the body 1b have no projection or depression on the surface, such as a switch.

The handy pump 1 has a display window 7. The display window 7 emits light so that operating states of the below-mentioned electric pump device may be displayed. The head 1a is equipped with the display window 7 that is extended long and narrow along an outer circumference of the head 1a. The display window 7 extends in an annular shape to surround an outer circumference of the head 1a. The display window 7 is continuously extended annularly along the outer periphery of the head 1a. The display window 7 is the only one linear irregularity on the surface of the head 1a. The display window 7 has narrow width. An emission surface 8c of a light-guide plate is exposed at the display window 7. The handy pump 1 may be put in an illustrated vertical attitude by placing the head 1a above, placing the body 1b below, and put the bottom end of the body 1b to contact on a base, such as a table. The body 1b has a thickness which can allow maintaining this vertical attitude stably.

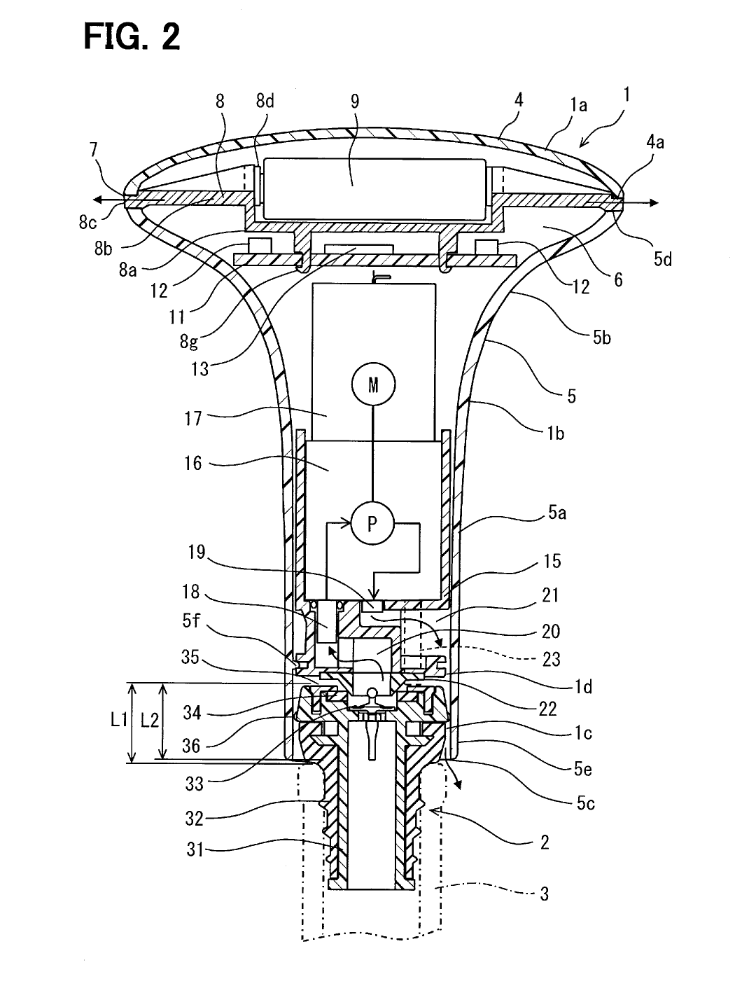

Referring to FIG. 2, the handy pump 1 has an upper case 4 and a lower case 5. The upper case 4 and the lower case 5 form a case which can be held by hand and defines an outer shape of the handy pump 1. The upper case 4 and the lower case 5 accommodate an electric pump device mentioned later. The upper case 4 and the lower case 5 are formed to be engaged and disengaged by a snap fit mechanism. The upper case 4 and the lower case 5 may be formed to be engaged and disengaged by using a tightening member, such as a screw. The upper case 4 and the lower case 5 are made of hard resin. The upper case 4 and the lower case 5 have surfaces that are covered with non-translucent paint or plating. The upper case 4 and the lower case 5 may be made of metal.

Between the upper case 4 and the lower case 5, a machine chamber 6 for accommodating functional part of the handy pump 1 is formed and defined. The machine chamber 6 may be used as a light-guide cavity through which light for display is guided. The upper case 4 is a shallow cap formed in an ellipse form.

The upper case 4 provides an upper half of the head 1a. An open end of the upper case 4 provides an edge 4a of an ellipse form. The lower case 5 is a shape like a funnel which is slightly shallow. The lower case 5 has the cylindrical shank 5a which provides the body 1b, and a flare part 5b of an elliptic tube shape which is formed to spread gradually upwardly from the shank 5a. The flare part 5b provides a lower half of the head 1a. An open end 5c is formed by a circular opening at a lower end of the shank 5a. The open end 5c is a connection opening for being connected with the below-mentioned plug 2 and container 3. The open end on an upper end of the flare part 5b provides an edge 5d of an ellipse form. The edge 5d is located to be spaced apart from the edge 4a by a predetermined distance. The edges 4a and 5d form and define the display window 7 by being positioned in a face to face manner with a narrow clearance.

A lower part of the shank 5a provides a cylindrical guide cap 5e. The guide cap 5e may be placed to cover an outside of the plug and/or an opening end of the container 3. The guide cap 5e forms and defines a cavity for accommodating a plug head of the plug 2 therein. The guide cap 5e provides a guide member for placing the handy pump 1 at a proper position with respect to the plug 2 and/or the opening end of the container 3.

In the drawing, the plug 3 that works with the handy pump 1 is illustrated. The plug 2 is attached on the opening of the container 3. The container 3 illustrated is a bottle of drinks, such as wine. The plug 2 is a plug with a valve which permits only discharging air flow, i.e., exhaust, from the container 3, or permits only charging air flow to the container 3. The plug 2 illustrated has a valve which permits only discharging air flow from the container 3.

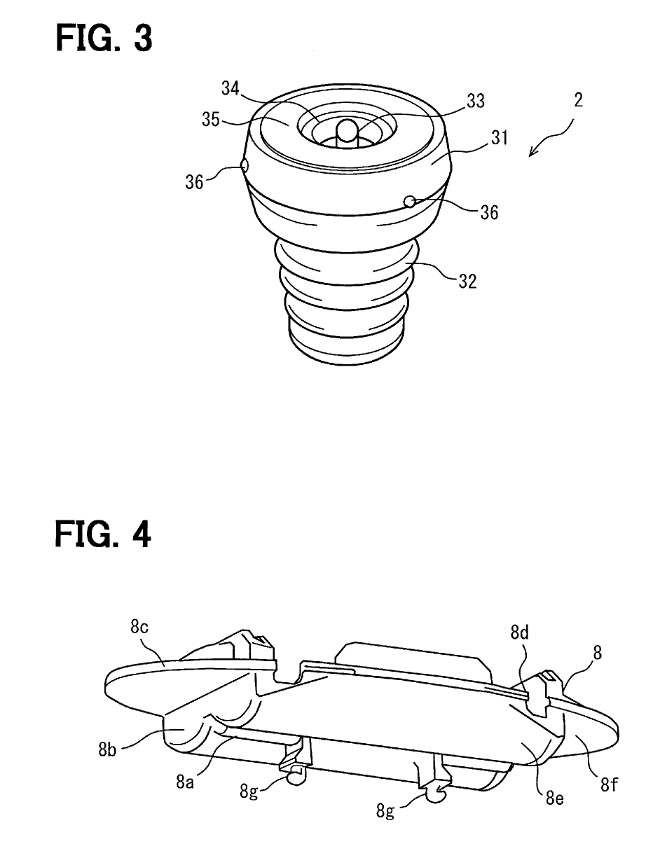

In FIGS. 2 and 3, the plug 2 has a cylindrical core 31. The core 31 has a shank which can be attached to the opening of the container 3, and a plug head which can be connected with the handy pump 1. The plug 2 has a seal member 32 arranged between the core 31 and the container 3, for providing airtightness. The seal member 32 is put on an outside of the core 31. The plug 2 has a valve 33 arranged in a passage in the core 31. The valve 33 is an umbrella valve which permits only the exhaust from the container 3. The valve 33 can be provided by various forms of valves, such as a ball valve, a needle valve, and a duck bill. The plug 2 has a gasket 34 attached on the plug head of the core 31. The gasket 34 enables airtightness connection with the handy pump 1. The plug 2 has a retainer 35 for holding and fixing the gasket 34. The retainer 35 is connected and fixed to the core 31 by a snap fit mechanism. The core 31 and the retainer 35 are made of hard resin. The seal member 32, the valve 33, and the gasket 34 are made of elastic resin.

A plurality of spacers 36 are formed on an outer circumferential surface of the cylindrical plug head of the core 31. The plug head has a plurality of spacers 36 which are arranged in a spaced apart manner along a circumferential direction. The spacer 36 is a projection in a semi-spherical shape projecting partially at an outer circumferential surface of the plug head. The illustrated core 31 has three spacers 36 arranged at equal intervals along the circumferential direction. The spacer 36 contacts an inner surface of the guide cap 5e, when the core 31 is positioned inside the guide cap 5e.

The spacer 36 makes it possible to secure an annular gap which almost surrounds all the outer circumference of the plug head around the plug head of the core 31. As a result, a clearance 1c for ventilation is defined between the plug head of the core 31 and the inner surface of the guide cap 5e. The clearance 1c communicates with the below-mentioned clearance 1d. The clearance 1c is extended long and narrow over the inner surface of the guide cap 5e. Although the clearance 1c is divided by the spacer 36, the clearance 1c may be explained to extend over entire circumference along the inner surface of the guide cap 5e. The clearance 1c has a plurality of semi-circular portions which are distributed over entire circumference along the inner surface of the guide cap 5e. As a result, possibility of blocking or plugging of the clearance 1c is reduced.

Returning to FIG. 2 a light-guide plate 8 is arranged in the machine chamber 6. The light-guide plate 8 is arranged in the head 1a. The light-guide plate 8 is arranged on a radial inside of the display window 7. The light-guide plate 8 spreads mainly along a flat plane including the display window 7. The light-guide plate 8 partially contacts the inner surface of the lower case 5, and is fixed by a snap fit mechanism. The light-guide plate 8 is made of transparent or translucent resin.

The light-guide plate 8 guides light supplied from a light source 12 to the display window 7. The light-guide plate 8 is disposed to face to the light source 12, and has an incident surface 8a which receives light from the light source 12. The light-guide plate 8 provides a light-guide portion 8b which guides light by reflecting light therein. The light-guide portion 8b guides light received from the light source 12 towards the display window 7. The light-guide plate 8 has an emission surface 8c which emits light guided by the light-guide portion 8b. The emission surface 8c is arranged in an inside of the display window 7, or a radial inside of the display window 7. The emission surface 8c is arranged to be exposed to an outside of the cases 4 and 5 at the display window 7. In this structure, the inside of the display window 7 is filled with the light-guide plate 8. In other words, the display window 7 is filled and closed with the emission surface 8c. The light-guide plate 8 is a single plate which has the emission surface 8c on an outer rim extending along the display window 7.

The light-guide plate 8 is also a holder for supporting functional components accommodated in the machine chamber 6. The light-guide plate 8 is formed as a battery holder 8d for supporting a battery 9. The light-guide plate 8 has a container section 8e formed in a semi-cylindrical shape which accommodates and holds the battery 9. The light-guide plate 8 has a plate portion 8f formed in a flat plate shape which spreads towards the display window 7 on a radial outside of the container section 8e. The battery 9 is a rechargeable battery which can charge or discharge, or a dry cell. The battery 9 supplies electric power to the below-mentioned light source 12, control circuit 13, and the motor 17. The battery 9 may be changed by separating the upper case 4 and the lower case 5. In a case that the battery 9 is a rechargeable battery, the rechargeable battery 9 may be charged via a charge terminals arranged inside the guide cap 5e. The light-guide plate 8 is formed as a board holder 8g which supports a circuit board 11 on which the control circuit 13 for providing a controller is mounted. The circuit board 11 is supported by the light-guide plate 8, without contacting the lower case 5. The light-guide plate 8 and the circuit board 11 are arranged in parallel.

The controller 12 is an electronic control unit. The controller has at least one processing unit (CPU) and at least one memory (MMR) as a storage medium which stores and memorizes a program and data. The controller is provided by a microcomputer which has a storage medium which can be read by computer. The storage medium is a non-transitory storage medium which stores a program readable by the computer. The storage medium may be provided with semiconductor memory or a magnetic disc. The controller may be provided with a computer or a set of computer resources linked by a data communication device. The program, when the controller executes the program, makes the controller to function as the apparatus described in this specification, and makes the controller to function to perform methods, such as control method, described in this specification. The controller provides various components. At least a part of the components may be referred to as means for performing function, and from the other viewpoint, at least a part of the components may be referred to as compositional block or module.

The circuit board 11 carries a light emitting diode, i.e., LED as the light source 12. The circuit board 11 has two light sources 12. Two light sources 12 are arranged being spaced apart each other along a longitudinal direction of the light-guide plate 8. The light sources 12 are arranged to supply light so that light is entered towards the incident surface 8a of the light-guide plate. The light sources 12 are accommodated in the case 4 and 5. Lighting condition of the light sources 12 changes so that operating state of the electric pump device mentioned later is displayed.

The circuit board 11 carries the control circuit 13. The control circuit 13 controls an operating period of the motor 17. The control circuit 13 controls activating condition of the light source 12. The control circuit 13 changes activating condition of the light source 12 to indicate the operating state of the handy pump 1. The control circuit 13 can control the light source 12 to display the operating state of the handy pump 1 by using various activating conditions.

For example, the control circuit 13 may control the light source 12 to emit light only during an activation of the motor 17 and the pump 16. For example, the control circuit 13 may control the light source 12 to different lighting conditions in a plurality of stages from a beginning of discharge to an end of discharge performed by the handy pump 1. For example, the control circuit 13 may control the light source 12 as follows: in a continuously activated condition, i.e., continuous light emitting condition, in an initial stage; in a flashing condition alternately being activated and being deactivated with an even interval in a middle stage; in a short flashing condition for a limited number of flashes in an final stage; and in a turned off condition after the above-mentioned operation.

Alternatively, the light source 12 may be a multicolor light source. In this case, the control circuit 13 may control the multicolor light source 12 to change color according to the stages. For example, the control circuit 13 may control the multicolor light source 12 in a red light at the initial stage and in a green light at the final stage.

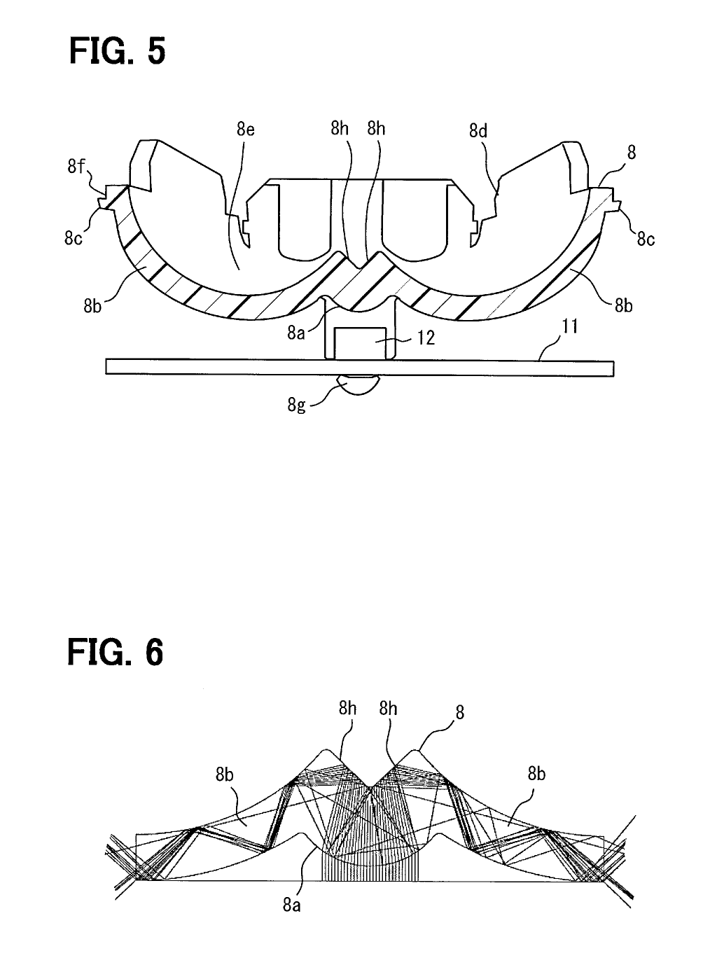

As shown in FIG. 4 and FIG. 5, the light-guide plate 8 is formed in a shape like a boat hull that can be used as the battery holder 8d. The light-guide plate 8 has two depressions for accommodating two battery cells 9. Electrode plates for providing electric connection with the battery 9 are disposed on the light-guide plate 8. The light-guide plate 8 has hooks as the board holder 8g. The hooks as the board holder 8g are inserted in openings formed on the circuit board 11, and being engaged with the circuit board 11.

The light source 12 is fixed on the circuit board 11 to supply light towards the light-guide plate 8. The light source 12 is arranged directly under a center line of the light-guide plate 8. The light source 12 is positioned on a center between two depressions for accommodating two battery cells 9. Two light sources 12 are arranged along a longitudinal direction of the light-guide plate 8. Two light sources 12 are arranged corresponding to the both ends of the longitudinal direction of the light-guide plate 8.

The incident surface 8a is positioned to face the light source 12. The incident surface 8a is positioned on a center of a short-hand direction of the container section 8e. The incident surface 8a is formed on an underside surface of the container section 8e. The incident surface 8a is provided by a lens surface which is a convex shape towards the light source 12. The lens surface converges light from the light source 12. The lens surface is a cylindrical lens which extends long and narrow along the longitudinal direction of the light-guide plate 8.

As shown in FIG. 5 and FIG. 6, the light-guide plate 8 has a pair of reflective surfaces 8h and 8h which are formed on an opposite side to and facing the incident surface 8a, are arranged in a V shape in cross section, and distribute light received. The plurality of reflective surfaces 8h and 8h reflect light received from the incident surface 8a towards different directions. The plurality of reflective surfaces 8h and 8h distribute light entered from the incident surface 8a towards two depressions on both sides.

The incident surface 8a converges light supplied from the light source 12. The incident surface 8a converges light towards the reflective surfaces 8h and 8h. The reflective surfaces 8h and 8h reflect light towards the right side and left side directions. The light reflected by the reflective surfaces 8h and 8h oriented and guided to the emission surface 8c by being reflected within the light-guide plate 8. Curved and flat surfaces other than the reflective surfaces 8h and 8h also works as reflective surfaces which reflect light in the light guide plate 8 and guide light towards the light emitting surfaces 8c.

According to this structure, light received from the incident surface 8a can be distributed in required directions according to the shape of the light-guide plate 8. A length of a light guide path tends to become long in order to provide a configuration suitable as the battery holder 8d and the container section 8e. It is difficult to guide light in a direction with long light guide path, i.e., the right and left direction in FIG. 5 and FIG. 6. According to the embodiment, it is possible to supply light positively in the right and left direction in FIG. 5 and FIG. 6, i.e., a horizontal direction. Thereby, light can be uniformly supplied to the entire display window 7 surrounding the head 1a. As a result, distribution of brightness is reduced in the display window 7.

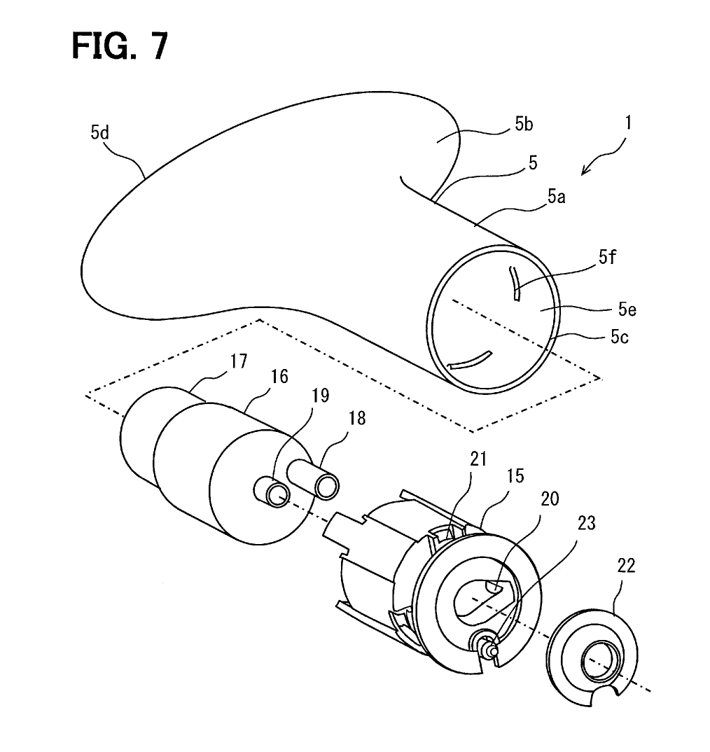

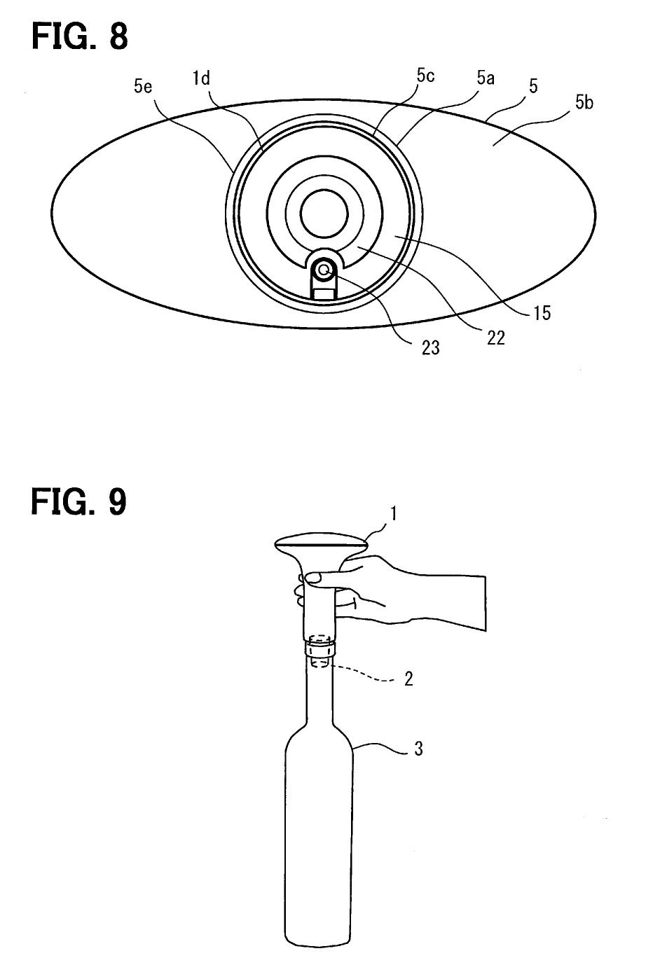

Returning to FIG. 2, an inner case 15 is arranged in the machine chamber 6. The inner case 15 is a member formed in a substantially cylindrical shape having a bottom plate on one end thereof. A shape of the inner case 15 may be understood in detail by referring to FIGS. 7 and 8. The inner case 15 is inserted into the lower case 5 and is engaged thereon by a snap fit mechanism. A bottom plate of the inner case 15 is engaged with a plurality of engagement projections 5f. The engagement projections 5f are arranged on an inner surface of the lower case 5 in a distributed manner along a circumferential direction.

The inner case 15 is a holder which supports the pump 16 and the motor 17 which provide the electric pump device. The pump 16 and the motor 17 are fixed to the inner case 15. The pump 16 can be provided by various forms of pumps, such as a piston pump, a diaphragm pump, and a vane pump. The pump 16 may have a cam mechanism provided as a converting mechanism for converting rotation of the motor 17 to reciprocal motion, and a piston driven by the cam mechanism, for example. The pump 16 has a suction port 18 which sucks air, and a discharge port 19 which discharges air. The pump 16 may have a valve system which defines an air flow direction in one way.

The inner case 15 is also a member for contacting the plug 2 in an airtight manner. A nozzle 22 is fixed on a bottom of the inner case 15. The nozzle 22 has a conical projection for connecting with the plug 2 in an airtight manner. The nozzle 22 is fixed to the inner case 15 by adhesion or a snap fit mechanism. The nozzle 22 is formed to be able to contact with the plug head of the plug 2 which has a valve 33. The electric pump device provided by the pump 16 and the motor 17 sucks or discharges air through the nozzle 22. The nozzle 22 may be integrally molded with the inner case 15. The inner case 15 is made of hard resin. The nozzle 22 is made of elastic resin.

The inner case 15 is a member forming a passage which defines the suction passage 20 and the discharge passage 21 independently. The suction passage 20 opens at the center of the inner case 15 to communicate to the central opening of the plug 2. The suction passage 20 is formed to communicate to the suction port 18 of the pump 16. The discharge passage 21 is formed to be extended continuously from the discharge port 19 of the pump 16. The discharge passage 21 is extended toward a radial outside direction from the center of the inner case 15, and is formed to open on a radial outside surface of the inner case 15. The inner case 15 has an annular discharge groove arranged to surround the outer circumference of the inner case 15. An inner surface of the lower case 5 is located on a radial outside of the discharge groove.

A diameter of an outer surface of the inner case 15 is formed slightly smaller than a diameter of an inner surface of the lower case 5. As a result, a clearance 1d for ventilation, i.e., discharge air flow, is formed between the inner case 15 and the lower case 5. The clearance 1d is formed also on portions where the engagement projections 5f are disposed. The clearance 1d communicates to the inside of the guide cap 5e through an outer circumferential surface of the inner case 15 from the discharge passage 21. The clearance 1d is defined along an inside surface of the guide cap. The clearance 1d extends so that air may be passed in a direction opposite to a direction of air flow in the nozzle 22. In the drawing, the clearance 1d is illustrated in a manner that the clearance 1d extends in the up and down direction in FIG. 2, i.e., extends along the axial direction of the lower case 5.

The clearance 1d is a semi-circular shape and is not an annular shape at a portion where the plurality of engagement projections 5f is formed. However, the clearance 1d is an annular shape before and after the engagement projections 5f. An outward opening of the clearance 1d is positioned on the radial outside of the nozzle 22. The clearance 1d spreads long and narrow in at least a semi-circular manner to surround the radial outside of the nozzle 22. An outward opening of the clearance 1d spreads long and narrow in at least a semi-circular manner on the radial outside of the nozzle 22. The clearance 1d spreads long and narrow in an annular shape to surround the nozzle 22. The clearance 1c opens in an annular shape between the guide cap 5e and the inner case 15 is illustrated in FIG. 8.

The inner case 15 is also a holder which holds an electric switch 23 for detecting a coupling with the plug 2. The switch 23 is arranged on a position facing to an upper end surface of the plug 2. The inner case 15 has a U-shaped recessed portion next to the nozzle 22 in order to places the switch 23. The recessed portion also provides passage for communicating the electric pump device and the air. This recessed portion is also a part of the clearance 1d.

The battery 9 and the control circuit 13 are electrically connected by conductive wires. The control circuit 13 and the motor 17 are electrically connected by conductive wires. The control circuit 13 and the switch 23 are electrically connected by conductive wires. The switch 23 detects that the nozzle 22 is strongly forced to the plug 2, and transmits electrical signal to the control circuit 13. The control circuit 13 then performs a series of discharge sequence in response to the detection signal from the switch 23. In the discharge sequence, the electric pump device is activated and operated until the operation is continued for a predetermined period of time or until pressure condition in the container 3 reaches a predetermined goal condition. Simultaneously, activating condition of the light source 12 is controlled to display the stages of the discharge sequence, such as a beginning stage, a progressing stage, and a final stage, i.e., a completion of the sequence.

The inner case 15 is thoroughly accommodated in the shank 5a. The inner case 15 is arranged in the shank 5a so that the guide cap 5e further extends axially from the bottom of the inner case 15. The guide cap 5e extends still longer than the bottom plate the inner case 15, i.e., the nozzle 22. In other words, the nozzle 22 is thoroughly accommodated in the guide cap 5e. The guide cap 5e is disposed on a radial outside of the nozzle 22 to surround the nozzle 22. The guide cap 5e is extended higher than the nozzle 22. The nozzle 22 is positioned at an axially inward position which is recessed inwardly from the open end 5c by a predetermined distance. The clearance 1d has an open end which opens outwardly, i.e., an outer end, is positioned on the most inward position on the radial inside of the guide cap 5e, i.e., the deepest position. The clearance 1d opens at the deepest position on the inside of the guide cap. The outward open end of the clearance 1d spreads along a radial inside surface of the guide cap 5e.

The switch has a distal end which slightly projects from the bottom surface of the inner case 15 in order to contact the plug 2. The distal end of the switch 23 is positioned at an axially inward position from the open end 5c by a predetermined distance.

Even if the handy pump 1 is placed on a table, the nozzle 22 and the switch 23 are arranged not to contact on the surface of the table. Thereby, unnecessary activation of the handy pump 1 can be avoided. Moreover, the cleanliness of the nozzle 22 is maintained.

The plug 2 is formed so that the plug head protrudes from the end of the the container 3 by a predetermined protruding height L1 of the plug head when the plug 2 is attached on the opening of the container 3. The protruding height L1 is defined by the height of the plug head and the thickness of the seal member 32. The guide cap 5e and the inner case 15 are formed so that they can receive the plug head of the plug 2 through the open end 5c by the predetermined receiving depth L2. The protruding height L1 is greater than the receiving depth L2 (L2<L1). The length of the guide cap 5e is set to provide this relationship. Thereby, it is possible to avoid a blocking or plugging of the open end 5c caused by contacting the the open end 5c onto the end of the container 3.

A diameter of the inner surface of the guide cap 5e is larger than the plug head of the plug 2. The diameter of the inner surface of the guide cap 5e is larger than the outside diameter of an opening defining portion of many containers 3 which are assumed to be used with the handy pump 1. Thereby, even if the guide cap 5e is put to cover the opening defining portion of the container 3, blockade of the open end 5c is avoided. In the illustrated embodiment, the diameter of the inner surface of the guide cap 5e is set larger than the outside diameter of the opening defining portion of almost all wine bottles.

FIG. 9 shows an example of an operating state of the handy pump 1 and the plug 2. The cases 4 and 5 of the handy pump 1 configured as mentioned above have the open end 5c in which the nozzle 22 opens, and the head 1a disposed on the opposite side of the open end 5c. A user can understand intuitively that the only one open end 5c is a portion to be coupled with the plug 2.

An example of the container 3 is a bottle of wine. The plug 2 is attached on the opening of the container 3. A user places the handy pump 1 above the plug 2. A user puts the guide cap 5e on the outside of the plug 2. The gasket 34 of the plug 2 and the nozzle 22 contacts firmly, and the upper end surface of the plug 2 pushes the switch 23. According to this structure, a user can initiate the discharge sequence without operating manual switches. Moreover, the handy pump 1 may be designed to have a shape that has no manual switch exposed outside.

If the switch 23 detects contact, the control circuit 13 performs the discharge sequence. The control circuit 13 activates and operates the motor 17. The pump 16 is activated by being driven by the motor 20. The pump 16 sucks air in the container 3 via the valve 33. Air is inhaled from the suction port 18 via the suction passage 20. Air is discharged from the discharge port 19.

The cases 4 and 5 of this embodiment have a clearance 1d for ventilation which communicates the electric pump device and the air. The clearance 1d is arranged on a radial outside of the nozzle 22 to surround the nozzle 22. Air flows out to the clearance 1d from the discharge port 19 through the discharge passage 21. The clearance 1d is communicated to a portion located on a radial outside of the nozzle 22 and on a radial inside of the guide cap 5e. Therefore, air flows out to the inside of the guide cap 5e via the clearance 1d. Since the air flow passing through the clearance 1d flows to surround the nozzle 22 at the radial outside of the nozzle 22, the air flow will be distributed over a wide range. The clearance 1c is formed by a spacer 36 at a portion between the plug 2 and the guide cap 5e. Air is discharged from the open end 5c through the clearance 1c.

The clearance 1d makes it possible to discharge air out of the cases 4 and 5, without spoiling the appearance which the cases 4 and 5 provide, since the clearance is arranged inside the guide cap 5e. Moreover, the clearance 1d makes it possible to discharge air to the exterior, without requiring excessive number of components. Air blowing off from the discharge port 19 flows through the inside of the discharge passage 21 formed by the inner case 15, and is discharged inside the guide cap 5e through the clearance 1d. In addition, air is discharged through the outside of the inner case 15, in other words, is discharged along the inner surface of the lower case 5. Air discharged from the discharge port 19 is diffused gradually, and the flow velocity falls. Therefore, unpleasant noise is reduced. Since air is discharged in the guide cap 5e, air blows off towards the bottom of the handy pump 1. Thereby, it is reduced that air flow collides on a user.

During the discharge sequence is performed, the control circuit 13 activates the light source 12 to emit light. Light of the light source 12 is supplied to the outside of the head 1a from the display window 7. Thereby, a state in which at least the discharge sequence is performed is displayed. In addition, the control circuit 13 changes lighting condition according to the stages of the discharge sequence. Thereby, progress or the stages of the discharge sequence is displayed. The display window 7 extends long and narrow in an annular shape to completely surround the outer circumference of the head 1a. The emission surface 8c of the light-guide plate 8 is arranged at the display window 7. Thereby, it is possible to supply light to the display window 7 extending long and narrow over a wide range by a small number of light sources 12. Even if a user holds the head 1a, at least some part of the display window 7 are exposed, and the operating state may be displayed.

After the discharge sequence is completed, the control circuit 13 stops the motor 17. Simultaneously, the control circuit 13 controls the lighting condition of the light source 12 to notify completion of the discharge sequence. For example, the control circuit 13 controls the light source 12 so that the light source 12 blinks by a characteristic pattern. As a result, the user can know completion of the discharge sequence. A user then separates the handy pump 1 from the plug 2. The plug 2 holds a depressurized condition in the container 3. The user can put the handy pump 1 on the table etc., while keeping the open end 5c downward.

### Second Embodiment

This embodiment is one of modifications based on a basic form provided by the preceding embodiment. In the preceding embodiment, light is supplied to the display window 7 only by the light-guide plate 8. Alternatively or in addition to the above, in this embodiment, the hollow cavity of the machine chamber 6 within the case 4 and 5 is used as a light path for supplying light.

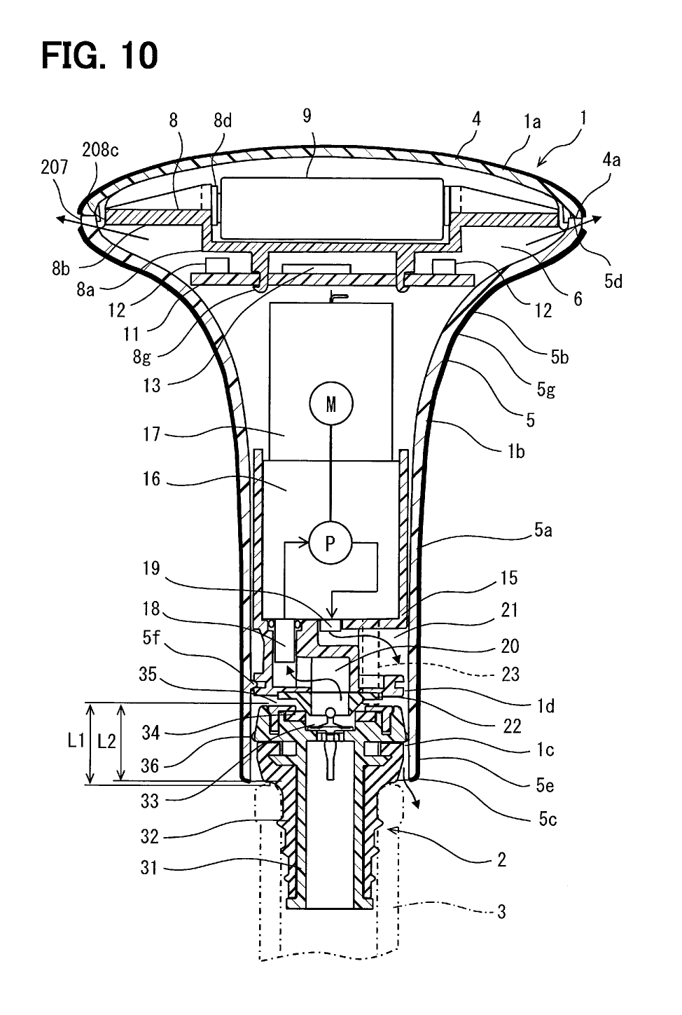

As shown in FIG. 10, the handy pump 1 has a display window 207 disposed along an edge 5d of the lower case 5. The lower case 5 is made of slightly clouded translucent resin. A non-translucent film 5g is formed on the surface of the lower case 5 except for a portion used as the display window 207. The film 5g may be provided by paint or plating. Therefore, the display window 207 is an optical permeation window using the translucent characteristic of the lower case 5. The display window 207 is in an annular shape continuously extending to surround the head 1a along the edge 5d. The display window 207 is a window formed in a slit shape.

The light which came out of the light source 12 arrives at the emission surface 208c via the light-guide plate 8. The emission surface 208c is arranged on a radial inside of the display window 207. Therefore, the light which came out from the emission surface 208c reaches the display window 207 while spreading. The display window 207 receives light from the machine chamber 6 and permits that light in the machine chamber 6 leaks outside. Light supplied into the machine chamber 6 from the light source 12 is reflected in the machine chamber 6, reaches to the display window 207, and leaks from the display window 207 to the outside. In addition, the lower case 5 works as a light-guide member. A part of light entered into the lower case 5 reaches the display window 207 via the inside of the lower case 5, and leaks from the display window 207 to the outside.

According to this embodiment, it is possible to supply light to the display window 207 without only depending on the light-guide plate 8. Light reflected by irregular reflection in the machine chamber 6 provides soft illumination in the display window 207. Light passing through the inside of the lower case 5 provides soft illumination in the display window 207.

### Third Embodiment

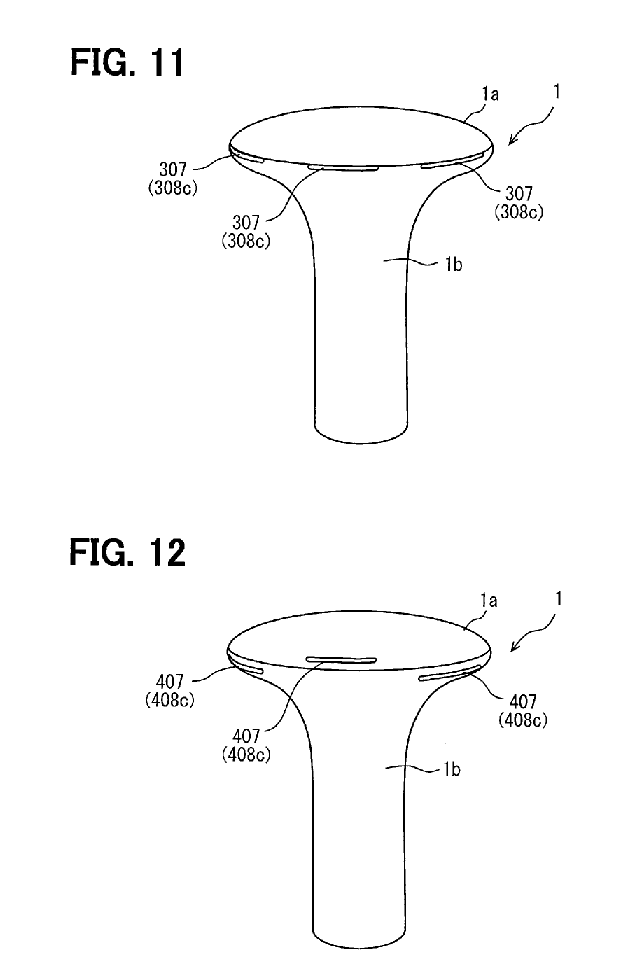

This embodiment is one of modifications based on a basic form provided by the preceding embodiment. In the preceding embodiment, the display window 7, which is continuous, is disposed to surround the head la. Alternatively, in this embodiment, as shown in FIG. 11, a plurality of display windows 307 are intermittently disposed to surround the head 1a.

The plurality of display windows 307 are formed between the upper case 4 and the lower case 5. The display window 307 is formed in a line shape extended long and narrow. The plurality of display windows 307 are arranged to surround the head 1a in an annular fashion. The head 1a has a plurality of display windows 307 which extend long and narrow along the outer circumference of the head 1a. A plurality of designation windows 307 are intermittently put in order annularly in accordance with the outer periphery of a head 1a.

The emission surfaces 308c of the light-guide plate 8 are arranged at corresponding display windows 307. Thereby, it is possible to supply light to the display windows 307 by using less number of light source 12 than that of display windows 307. Even if a user holds the head la, at least some display windows 307 are exposed, and the operating state may be displayed.

### Fourth Embodiment

This embodiment is one of modifications based on a basic form provided by the preceding embodiment. In the preceding embodiments, the display window 7 and 307 are formed between the upper case 4 and the lower case 5. Alternatively, in this embodiment, as shown in FIG. 12, a display window 407 is formed by an aperture penetrating the upper case 4 and/or an aperture penetrating the lower case 5.

A plurality of display windows 407 are formed by a plurality of apertures penetrating the upper case 4 and/or the lower case 5. The display window 407 is formed in a line shape extending long and narrow. Although the plurality of display windows 407 are arranged in an up and down shifting manner, the display windows 407 are still arranged in an annular fashion to surround the head la.

In this embodiment, it is possible to achieve similar functions and advantages in the preceding embodiments. In addition, according to this embodiment, it is possible to determine and design shapes of the display windows 407 without restrictions depending on the shape of the edges 4a and 5d.

### Fifth Embodiment

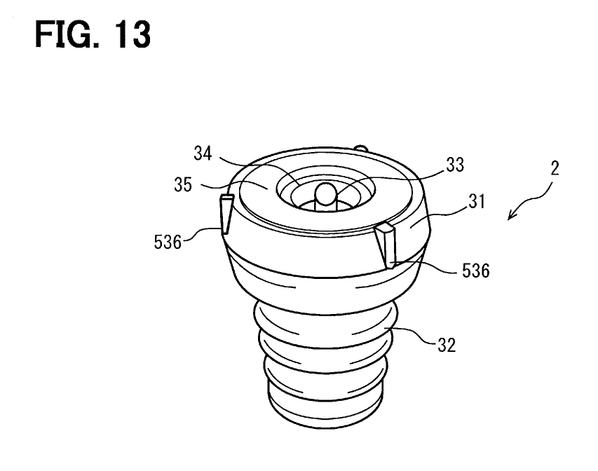

This embodiment is one of modifications based on a basic form provided by the preceding embodiment. In the preceding embodiment, the spacers 36 of semi-spherical shape are arranged on the plug 2. Alternatively, in this embodiment, as shown in FIG. 13, a plurality of spacers 536 formed in shapes which may be called as ribs or plates.

The spacers 536 are extended long and narrow along the axial direction of the plug 2. The spacers 536 contact the inner surface of the guide cap 5e along the axial direction. As a result, it is possible to reduce tilting of the axis of the guide cap 5e with respect to the axis of the plug 2. Thereby, the clearance 1c between the plug 2 and the guide cap 5e is certainly provided.

### Other Embodiments

The present disclosure is not limited to the above embodiments, and the present disclosure may be practiced in various modified embodiments. The present disclosure is not limited to the above combination, and disclosed technical means can be practiced independently or in various combinations. Each embodiment can have an additional part. The part of each embodiment may be omitted. Part of embodiment may be replaced or combined with the part of the other embodiment. The configurations, functions, and advantages of the above-mentioned embodiments are just examples. The technical scope of disclosure is not limited to the embodiment. Some extent of the disclosure may be shown by the scope of claim, and also includes the changes, which is equal to and within the same range of the scope of claim.

For example, means and functions of the control device 10 may be provided by only software, only hardware or a combination of the software and the hardware. For example, the control device may be made of an analogue circuit.

In the preceding embodiments, the handy pump 1 depressurizes the inside of the container 3. Alternatively, the handy pump 1 may be configured to pressurize the inside of the container 3. In this case, the motor 17 may be rotated in the reverse direction. The plug 2 may have, instead of the valve 33, a valve in a reverse operative direction to the valve 33. The suction port 18 turns into a discharge port. The discharge port 19 turns into a suction port. The suction passage 20 turns into a discharge passage. The discharge passage 21 turns into a suction passage. The clearances 1d and 1c provide a suction passage for the pump 16 to inhale air.

In the preceding embodiments, the container 3 is a bottle which accommodates a drink, such as wine. Alternatively, the pump 1 may be applied and used by attaching the plug 2 to a jar for food which has wider opening, or to a resin made sealable container for food. Moreover, the pump 1 may be applied and used by attaching the plug 2 to a container for chemicals or samples other than food.

In the preceding embodiments, the guide cap 5e is disposed. Alternatively, it is possible to provide a shorter guide cap. For example, the handy pump 1 may has a guide cap that has a length about the half of the protruding height L1 of the plug head of the plug 2. Moreover, the handy pump 1 may has a lower case without the guide cap 5e. In this structure, an opening defined by the clearance 1d spreads long and narrow in at least a semi-circular manner on the radial outside of the nozzle 22.

In the preceding embodiments, the bottom surface of the cavity in the guide cap 5e is provided by the bottom plate of the inner case 15 by arranging the inner case 15 in the lower case 5. Alternatively, a partitioning plate integrally molded with the lower case 5, or a separated partitioning plate may be disposed in the lower case 5. In this case, the bottom surface of the cavity in the guide cap 5e may be provided by the partitioning plate. In this case, the partitioning plate may be formed with a through hole for the nozzle 22 and a plurality of semi-circular through holes for the clearance 1d.

What is claimed is:

1. A handy pump, comprising:
an electric pump device which sucks or discharges air through a nozzle; and
a handy case which accommodates the electric pump device, wherein
the case has a clearance for ventilation which is arranged on a radial outside of the nozzle to surround the nozzle and communicates the electric pump device and the air.

2. The handy pump in claim 1, wherein
the case has a guide cap which is disposed to surround the nozzle at the radial outside of the nozzle, and extends higher than the nozzle, and wherein
the clearance is defined along an inside surface of the guide cap.

3. The handy pump in claim 2, wherein
the clearance opens at the deepest position on the inside of the guide cap.

4. The handy pump in claim 2, further comprising:
an inner case which is accommodated in the guide cap, and supports the electric pump device, wherein
the nozzle is disposed on the inner case, and wherein
the clearance is defined between the guide cap and the inner case.

5. The handy pump in claim 2, wherein
the nozzle is formed to be able to contact with a plug head of a plug having a valve,
the guide cap defines a cavity for accommodating the plug head, and
a protruding height L1 of the plug head protruding from a container when the plug is attached on an opening of the container is greater than an receiving depth L2 of the guide cap in which the guide cap can receives the plug head (L2<L1).

6. The handy pump in claim 5, wherein
an additional clearance communicated with the clearance is formed between the guide cap and the plug head.

7. The handy pump in claim 5, wherein
the plug head has a plurality of spacers which are arranged each other in a separated manner along a circumferential direction.

8. The handy pump in claim 1, wherein
the clearance extends so that air may be passed in a direction opposite to a direction of air flow in the nozzle.

9. The handy pump in claim 1, wherein
the clearance spreads long and narrow in at least a semi-circular manner to surround the nozzle.

10. The handy pump in claim 9, wherein
the clearance spreads in an annular shape.

11. A handy pump, comprising:
an electric pump device which sucks or discharges air through a nozzle, and
a handy case which accommodates the electric pump device, wherein
the case includes:
a guide cap which is disposed to surround the nozzle at the radial outside of the nozzle, and extends higher than the nozzle; and
a clearance for ventilation which is arranged on a radial outside of the nozzle and arranged on a radial inside of the guide cap, and communicates the electric pump device and the air.

12. The handy pump in claim 11, wherein
the clearance opens at the deepest position on the inside of the guide cap.

13. The handy pump in claim 11, further comprising:
an inner case which is accommodated in the guide cap, and supports the electric pump device, wherein
the nozzle is disposed on the inner case, and wherein
the clearance is defined between the guide cap and the inner case.

14. The handy pump in claim 11, wherein
the nozzle is formed to be able to contact with a plug head of a plug having a valve,
the guide cap defines a cavity for accommodating the plug head, and
a protruding height L1 of the plug head protruding from a container when the plug is attached on an opening of the container is greater than an receiving depth L2 of the guide cap in which the guide cap can receives the plug head (L2<L1).

15. The handy pump in claim 14, wherein
an additional clearance communicated with the clearance is formed between the guide cap and the plug head.

16. The handy pump in claim 14, wherein
the plug head has a plurality of spacers which are arranged each other in a separated manner along a circumferential direction.

17. The handy pump in claim 11, wherein
the clearance extends so that air may be passed in a direction opposite to a direction of air flow in the nozzle.

18. The handy pump in claim 11, wherein
the clearance spreads long and narrow in at least a semi-circular manner to surround the nozzle.

19. The handy pump in claim 18, wherein
the clearance spreads in an annular shape.
